(19) United States
(12) Patent Application Publication
(10) Pub. No.: US 2026/0087847 A1
(43) Pub. Date: Mar. 26, 2026

(54) EMBEDDED FACE IDENTIFICATION SYSTEM

(71) Applicant: Cypress Semiconductor Corporation, San Jose, CA (US)

(72) Inventors: Aidan SMYTH, Irvine, CA (US); Youngkwan CHO, Los Angeles, CA (US); Ashutosh PANDEY, Irvine, CA (US); Taras MAKSYMYUK, Lviv (UA)

(73) Assignee: Cypress Semiconductor Corporation, San Jose, CA (US)

(21) Appl. No.: 18/898,305

(22) Filed: Sep. 26, 2024

(51) Int. Cl. G06V 40/16; G06V 10/24; G06V 10/70

(52) U.S. Cl. CPC G06V 40/172; G06V 10/24; G06V 10/70; G06V 40/171

(57) ABSTRACT

An embedded face identification system that receives, from an image capture device, a captured image. A face image is extracted from the captured image. The extracted face image is aligned to a reference face model. A face embedding is generated using a machine learning model and based on the aligned extracted face image. An individual associated with the face embedding is identified based on the generated face embedding and a database of existing face embeddings.

### TECHNICAL FIELD

Aspects and implementations of the present disclosure relate to embedded face identification.

### BACKGROUND

Face identification (face ID) systems use computer vision and machine learning techniques to recognize or verify a person's identity based on their facial features. Embedded Face ID systems (i.e., face ID systems implemented on embedded devices) have gained significant traction in various applications due to their portability and convenience. These systems integrate sophisticated facial recognition algorithms into compact, often mobile devices, enabling real-time identification in diverse environments from smartphone unlocking to security checkpoints.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example computer system, in accordance with implementations of the present disclosure.

FIG. 2 illustrates an example continuous face detection component of an embedded face identification system of FIG. 1, in accordance with implementations of the present disclosure.

FIG. 3 illustrates an example on-demand face recognition component of the embedded face identification system of FIG. 1, in accordance with implementations of the present disclosure.

FIG. 4 depicts a flow diagram of an example method for embedded face identification, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to embedded face ID systems. With the significant traction in various applications of embedded face ID systems, embedded face ID systems incorporate a pipeline including face detection, landmark estimation, alignment, and identification steps. Face alignment normalizes detected images using similarity transformation based on five facial landmarks, while identification compares a newly captured face embedding against a database of stored embeddings.

However, two primary technical challenges impede the efficiency and accuracy of Embedded Face ID systems on devices with constrained computational resources. First, current alignment methods assume landmark coplanarity and uniform scaling, proving inadequate for non-frontal captures and resulting in suboptimal alignment for angled views. Second, as the number of stored embeddings expands, the system experiences a linear increase in high-dimensional vector comparisons, leading to increased processing time and resource consumption. This computational complexity adversely affects real-time performance. Consequently, there is a need for enhanced alignment techniques capable of handling non-frontal images and more efficient embedding comparison methods to improve the overall robustness, accuracy, and efficiency of these systems.

Aspects and embodiments of the present disclosure address these and other limitations of the existing technology by providing an embedded face identification that aligns a face image of a detected face using a homogenous transformation, and subsequently preprocesses the embedding of the detected face to allow for more efficient face identification. In particular, a system for embedded face identification continuously receives an image and detects whether a face is present in the image (e.g., detected face). The system aligns the detected face by identifying, using a homogenous transformation and one or more features of the detected face (e.g., left eye, right eye, and middle of lip), a set of parameters that would align the detected face to a reference face. The system generates, for the aligned detected face, an embedding (e.g., detected face embedding) which represents a unique numerical representation of the facial features. The system further performs dimensionality reduction on the embedding for quicker comparison with embeddings of known users (or enrolled users). The system calculates a similarity score between the detected face embedding and one or more representative embedding for each cluster within the embeddings of known users (or enrolled users). The system compares each calculated similar score with a predefined similarity score threshold assigned to each known users (or enrolled users). If the calculated similar score associated with the known user is satisfied (e.g., exceeds) the predefined similarity score assigned to the known user, the system determines that the detected face is the known user.

Aspects of the present disclosure overcome these deficiencies and others by improving accuracy of the face identification for non-frontal face images and efficiency of comparing embeddings.

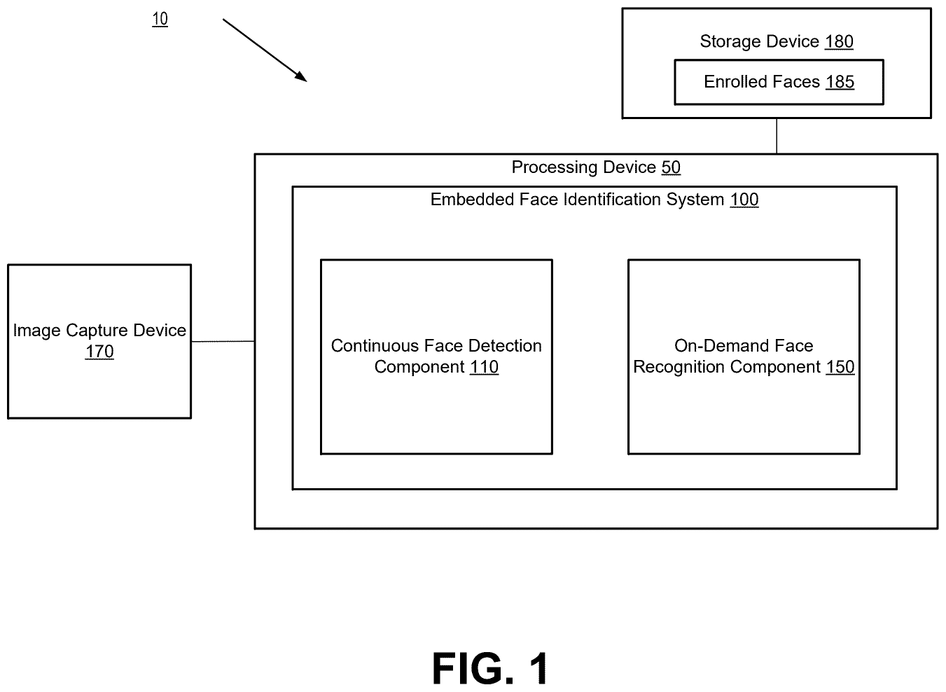

FIG. 1 is a simplified diagram of computer system 10, in accordance with implementations of the present disclosure. The computing system 10 may be a server, a workstation, a personal computer (PC), a mobile phone, a personal digital assistant (PDA), or any other suitable computing device. The computing system 10 includes a computing processing device (also referred to as processing device) 50, a capture device 170, and a storage device 180.

The processing device 50 includes various components capable of executing instructions that encode arithmetic, logical, or I/O operations. The processing device 50 may be a single-core or multi-core processor that can simultaneously execute multiple instructions. The processing device 50 can be implemented as a single integrated circuit, two or more integrated circuits, or as a component of a multi-chip module. The storage device 180 may include volatile and/or non-volatile memory, such as RAM, ROM, EEPROM, or any other devices capable of storing data.

The computing device 50 includes an embedded face identification system 100. The face identification system 100 includes a continuous face detection component 110 and an on-demand face recognition component 150 which collectively provide facial recognition.

The continuous face detection component 110 continuously receives input (e.g., captured images) from the image capture device 170 (e.g., a camera) coupled to the computing device 50 and conducts detection preprocessing, bounding box, and landmark detection to make a preliminary determination of whether a face is present in the captured image. Upon detection of a face, the on-demand face recognition component 150 aligns the detected face and conducts face ID preprocessing to prepare the aligned facial image for the identification. The on-demand face recognition component 150 generates an embedding which represents a unique numerical representation of the facial features and performs postprocessing to refine this representation. The on-demand face recognition component 150 compares the embedding of the detected face (e.g., detected face embedding) with embeddings of known faces in a database of enrolled faces 185 stored in storage device 180.

The database of enrolled faces 185 includes an embedding for each user that enrolled in facial recognition or detection (e.g., face identification). Each user, during enrollment, provides multiple images each with varying orientation of the face (e.g., yaw, pitch, and roll of the face). For each image of a user, a face in a respective image is detected and aligned, high-dimensional features are extracted and compressed into a compact, fixed-length vector that serves as the face's unique numerical representation (e.g., an embedding). Each user is assigned a unique similarity threshold (e.g., per-user similarity threshold) to distinguish it from other similar enrolled user (e.g., a sibling). In some embodiments, the per-user similarity threshold is a threshold value that distinguishes a user from all other users using a cosine distance between the user and each of the other users.

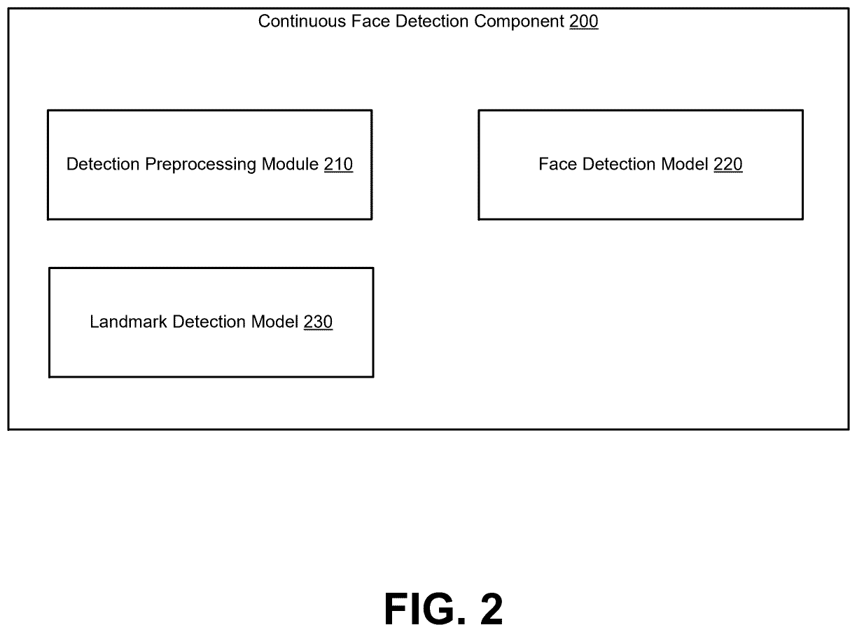

FIG. 2 is a simplified diagram of a continuous face detection component 200, similar to continuous face detection component 110 of FIG. 1, in accordance with implementations of the present disclosure. The continuous face detection component 200 can include a detection preprocessing module 210, a face detection model 220, and a landmark detection model 230. The preprocessing module 210, and similar modules, comprises executable instructions that are processed and executed by one or more processing devices.

The detection preprocessing module 210 resizes the image to match the input dimensions required by a neural network model trained for face detection (e.g., face detection model 220) while maintaining the integrity of the image and avoiding distortions. After resizing, the detection preprocessing module 210 performs image normalization to adjust pixel values of the image to fit within a specified input range based on the image's bit depth or precision. For instance, 32-bit floating-point (fp32) images would typically be normalized to a range of −1 to 1. Image normalization can include zero-centering or utilizing different mean and standard deviation values. The detection preprocessing module 210 converts the image (after resizing and normalization) to the desired precision to ensure that the bit depth of the output matches the requirements of the face detection model 220.

The face detection model 220 scans the entire image to generate multiple potential bounding boxes of varying sizes and positions using sliding windows and/or predefined anchor boxes. Each of these bounding boxes is assigned a confidence score, indicating the likelihood of the bounding box containing a face. In some embodiments, one or more techniques, such as Non-Maximal Suppression (NMS), systematically selects high-confidence bounding boxes while removing those that significantly overlap according to a predefined confidence threshold, ensuring that each face is represented by only one bounding box to eliminate redundancy. Each bounding box, defined by its coordinates within the original image, serves as a guide for extracting a sub-region containing a detected face. The face detection model 220 uses the coordinates of each bounding box (typically the x and y coordinates of the top-left corner, along with the width and height; other coordinate systems or reference locations may be used) to isolate (e.g., crop) the corresponding portion of the original image producing an individual face image that contain only the detected face.

The landmark detection model 230 identifies key facial landmarks (e.g., a facial landmark for each eye, a facial landmark for each corner of the mouth, and a facial landmark for the nose) in the face image. The landmark detection model 230 processes the face image through multiple layers, extracting relevant facial features and patterns used to predict the precise locations of key facial landmarks within the face image. The key facial landmarks are represented as coordinate points relative to the face image. The output of the landmark detection model 230 consists of coordinate values, effectively mapping the key facial features for the face in the face image.

In some embodiments, the face detection model 220 and the landmark detection model 230 can be integrated into a single, unified model that simultaneously detects faces and facial landmarks. In some embodiments, the face detection model 220 and the landmark detection model 230 can operate as separate, sequential components: the face detection model 220 first identifies faces and produces bounding boxes, followed by the landmark detection model 230 which processes these cropped face regions (associated with the bounding boxes) to identify specific facial landmarks.

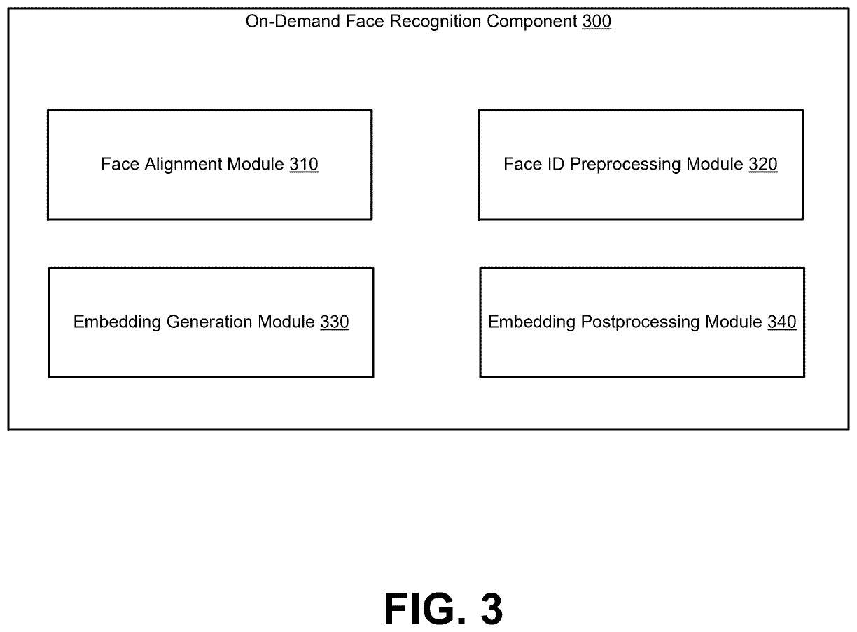

FIG. 3 is a simplified diagram of an on-demand face recognition component 300, similar to on-demand face recognition component 150 of FIG. 1, in accordance with implementations of the present disclosure. The on-demand face recognition component 300 includes a face alignment module 310, a face ID preprocessing module 320, an embedding generation module 330, and an embedding postprocessing module 340. The face alignment module 310, the face ID preprocessing module 320, the embedding generation module 330, the embedding postprocessing module 340, and similar modules, comprises executable instructions that are processed and executed by one or more processing devices.

The face alignment module 310, using a similarity transformation, aligns the face in the face image (e.g., detected face). Similarity transformation refers to a method of preserving the shape of an object (e.g., the detected face) during rotation, translation, and uniform scaling. Rotation refers to rotating the object by a certain angle. Translation refers to shifting or moving the object along the x and y axes. Uniform scaling refers to scaling the object by the same factor in both the x and y directions while maintaining the aspect ratio. These operations (rotation, translation, and scaling) can be combined into a single transformation, typically two dimensional (2D), that affects a set of points or an image. The transformation can be represented as:

$$s [ \begin{matrix}cos θ & - sin θ \\ sin θ & cos θ\end{matrix} ] [ \begin{matrix}x \\ y\end{matrix} ] + [ \begin{matrix}{t}_{x} \\ {t}_{y}\end{matrix} ] \qquad ( 1 )$$

This transformation equation encompasses four degrees of freedom: rotation (θ), uniform scaling(s), x-axis translation (tₓ), and y-axis translation (t_{y}). In face alignment, these four parameters are crucial for transforming a detected face to match a reference face. To determine these parameters, two pairs of corresponding points are used-typically key facial features on both the detected and reference faces. Two pairs are necessary because a single pair can only provide information about translation, whereas two pairs offer sufficient data to calculate all four transformation parameters. The first pair establishes a baseline for translation and rotation, while the second pair allows for the determination of scale and refines the rotation calculation. By comparing the positions, angles, and distances between these point pairs on both faces, the face alignment module 310 can compute the exact rotation, scaling, and translation needed to align the detected face with the reference face. Accordingly, the face alignment module 310 efficiently solves for all four parameters in the similarity transformation equation (e.g., equation (1)), enabling precise face alignment that adapts to individual facial geometries while standardizing position, orientation, and scale for subsequent recognition tasks.

Since there are at least five features in the detected face, least squares estimation can be used in face alignment to determine optimal parameters to minimize the overall difference between the points in the detected face and the points in the reference face, compensating for detection inaccuracies and facial variations. By leveraging all available data, it provides a more robust and accurate alignment compared to using just two pairs as required by the degree of freedom. However, with angled views, unlike eyes and lip corners that typically lie on one plane, the nose tip protrudes on a different plane which causes the nose tip's position to have different scales compared to other features. Least squares estimation, treating all points equally, does not account for this disparity which leads to inaccurate alignments in non-frontal views.

Instead, the transformation can be represented as a 3×3 matrix when using homogenous coordinates (e.g., homogenous transformation). The homogenous transformation can be represented as:

$$[ \begin{matrix}{x}^{′} \\ {y}^{′} \\ 1\end{matrix} ] = [ \begin{matrix}s \cdot cos θ & - s \cdot sin θ & {t}_{x} \\ s \cdot sin θ & s \cdot cos θ & {t}_{y} \\ 0 & 0 & 1\end{matrix} ] [ \begin{matrix}x \\ y \\ 1\end{matrix} ] \qquad ( 2 )$$

The homogenous transformation encompasses six degrees of freedom, instead of the four degrees of freedom, which includes parameters s·cos θ, −s·sin θ, s·sin θ, s·cos θ, x-axis translation (tₓ), and y-axis translation (t_{y}). Similarly, to determine these parameters three pairs of corresponding points are used—typically key facial features on both the detected and reference faces. The key facial features on both the detected and reference faces is typically the left eye, the right eye, and the middle of the lip which are on the same plane.

$$[ \begin{matrix}{x}_{0}^{′} & {x}_{1}^{′} & {x}_{2}^{′} \\ {y}_{0}^{′} & {y}_{1}^{′} & {y}_{2}^{′} \\ 1 & 1 & 1\end{matrix} ] = [ \begin{matrix}s \cdot cos θ & - s \cdot sin θ & {t}_{x} \\ s \cdot sin θ & s \cdot cos θ & {t}_{y} \\ 0 & 0 & 1\end{matrix} ] [ \begin{matrix}{x}_{0} & {x}_{1} & {x}_{2} \\ {y}_{0} & {y}_{1} & {y}_{2} \\ 1 & 1 & 1\end{matrix} ] \qquad ( 3 )$$

where x₀, y₀ refers to original points of the left eye (before transformation), x′₀, y′₀ refers to transformed points of the left eye (after transformation), x₁, y₁ refers to original points of the right eye (before transformation), x′₁, y′₁ refers to transformed points of the right eye (after transformation), x₂, y₂ refers to original points of the middle of the lip (before transformation), and x′₂, y′₂ refers to transformed points of the middle of the lip (after transformation).

Solving for the parameters of homogenous transformation includes for each pair of points (e.g., establishing two equations, forming an overdetermined system of linear equations when multiple point pairs are considered. The least squares method is then employed to find the best-fit parameters that minimize the overall error across all point pairs. Techniques such as Singular Value Decomposition (SVD) or normal equations can yield values for the parameters of homogenous transformation.

The face alignment module 310 constructs the 3×3 matrix with the obtained parameters:

$$[ \begin{matrix}s \cdot cos θ & - s \cdot sin θ & {t}_{x} \\ s \cdot sin θ & s \cdot cos θ & {t}_{y} \\ 0 & 0 & 1\end{matrix} ] \qquad ( 4 )$$

and applies it to each pixel of the face image. The resulting non-integer pixel coordinates undergo interpolation, typically using bilinear or bicubic methods, to generate a new, aligned face image. This aligned image features standardized size, orientation, and facial feature positions, conforming to the reference image.

The face ID preprocessing module 320, similar to the detection preprocessing module 210, normalizes the aligned face image to adjust pixel values and converts the aligned face image to the desired precision, data type, channel order, contrast enhancement, and/or noise reduction.

The embedding generation module 330 receives the face image and passes it through a pre-trained neural network model trained to process the input image and outputs an embedding (e.g., detected face embedding). In some embodiments, the pre-trained neural network model may be optimized using specialized loss functions such as contrastive, triplet, quadruplet, or additive angular margin loss which enhance the model's ability to distinguish between different individuals. Ideally, the embeddings for different images of the same person cluster together in the high-dimensional space, while embeddings of different individuals remain distinctly separated which is crucial for accurate face recognition and identification.

The embedding postprocessing module 340 reduces the dimensionality of embedding received from the face ID preprocessing module 320. The embedding postprocessing module 340 may perform dimensionality reduction using various techniques, such as, principal component analysis, t-distributed stochastic neighbor embedding (t-SNE), uniform manifold approximation and projection (UMAP), etc.

Once the dimensionality of the embedding is reduced, the embedding postprocessing module 340 calculates a similarity score between the detected face embedding and each embedding of the database of enrolled faces (e.g., the database of enrolled faces 185 of FIG. 1). In some embodiments, rather than calculating a similarity score between the detected face embedding and each embedding of the database of enrolled faces, the embedding postprocessing module 340 calculates a similarity score between the detected face embedding and one or more representative embeddings from each cluster of embeddings in the database of enrolled faces. The embedding postprocessing module 340 identifies one or more representative embeddings for each cluster of embeddings in the database of enrolled faces using various techniques, such as, nearest neighbors, clustering centroids, K-nearest neighbors (KNN), support vector machines (SVM), etc.

The embedding postprocessing module 340 compares each similarity score with each per-user similarity threshold associated with an enrolled user. If the similarity score exceeds a per-user similarity threshold associated with an enrolled user, the embedding postprocessing module 340 indicates that the detected face is likely the enrolled user. Otherwise, the detected face is likely not to be the enrolled user. In some embodiments, once it is determined that there is a match, other techniques, such as OpenCV library, may be used to track the detected face and identities until the detected face leaves the frame to provide quicker and more efficient tracking of detected faces.

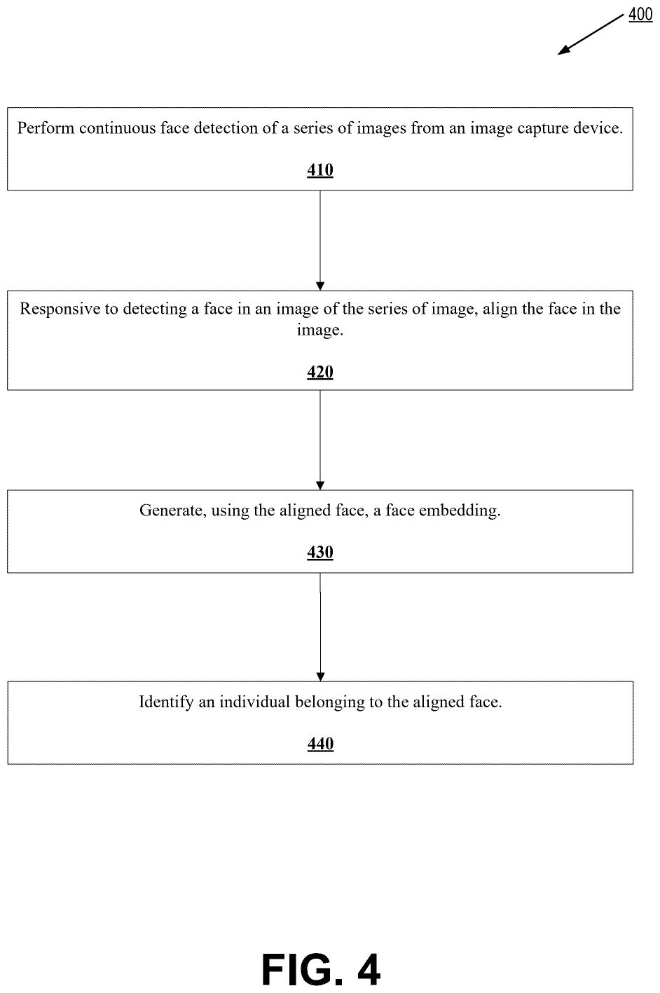

FIG. 4 is a flow diagram of a method 400 for embedded face identification, in accordance with implementations of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the embedded face identification system 100.

At operation 410, the processing logic performs continuous face detection of a series of images from an image capture device. As previously described, the processing logic continuously receives, as input, images captured by the image capture device. In some embodiments, resizes the image to match the input dimensions of a face detection model which scans the input to generate potential bounding boxes. Each potential bounding box is assigned a confidence score indicating the likelihood of the bounding box containing a face. If the confidence score exceeds a predefined confidence threshold (i.e., detecting a face), the coordinate of the bounding box is used to produce a face image that contain the detected face. The processing logic identifies key facial landmarks in the face image.

At operation 420, responsive to detecting a face in an image of the series of image, the processing logic aligns the face in the image. In some embodiments, the face in the face image is not aligned with respect to a reference face. Accordingly, the processing logic determines parameters of a homogenous transformation using the key facial landmarks in the face image and key facial landmarks in a reference face. After determining the parameters of the homogenous transformation, the processing logic applies the homogenous transformation with the determined parameters to each pixel of the face image to align the face to a reference face. In other words, the face in the face image is sized, oriented, and position to conform to the reference face.

At operation 430, the processing logic generates, using the aligned face, a face embedding. As previously described, the face image of the aligned face is passed through a pre-trained neural network model trained to process the input image and outputs a face embedding. The trained neural network model, ideally, produces embeddings for different images of the same person that cluster together in the high-dimensional space, while producing embeddings of different individuals that are distinctly separated. In some embodiments, the processing logic may reduce the dimensionality of face embedding.

At operation 440, the processing logic identifies an individual belonging to the aligned face. For each face embedding of a database of enrolled faces, the processing logic calculates a similarity score between the generated face embedding and a respective face embedding and then compares the similarity score to a similarity threshold value of the respective face embedding to determine whether an enrolled user associated with the respective face embedding matches the generated face embedding. If so, the individual associated with the generated face embedding is the enrolled user associated with the respective face embedding. Otherwise, the individual associated with the generated face embedding is not the enrolled user associated with the respective face embedding.

Depending on the embodiment, the processing logic may identify a representative face embedding for each cluster of face embeddings in the database of enrolled faces. For each representative face embedding, the processing logic calculates a similarity score between the generated face embedding and a respective representative face embedding and then compares the similarity score to a similarity threshold value of the representative face embedding to determine whether an enrolled user associated with the respective representative face embedding matches the generated face embedding. If so, the individual associated with the generated face embedding is the enrolled user associated with the respective representative face embedding. Otherwise, the individual associated with the generated face embedding is not the enrolled user associated with the respective representative face embedding.

The similarity threshold value for each face embedding of the database of enrolled faces or the representative face embedding is assigned based on the user that corresponds to the face embedding of enrolled faces or the representative face embedding.

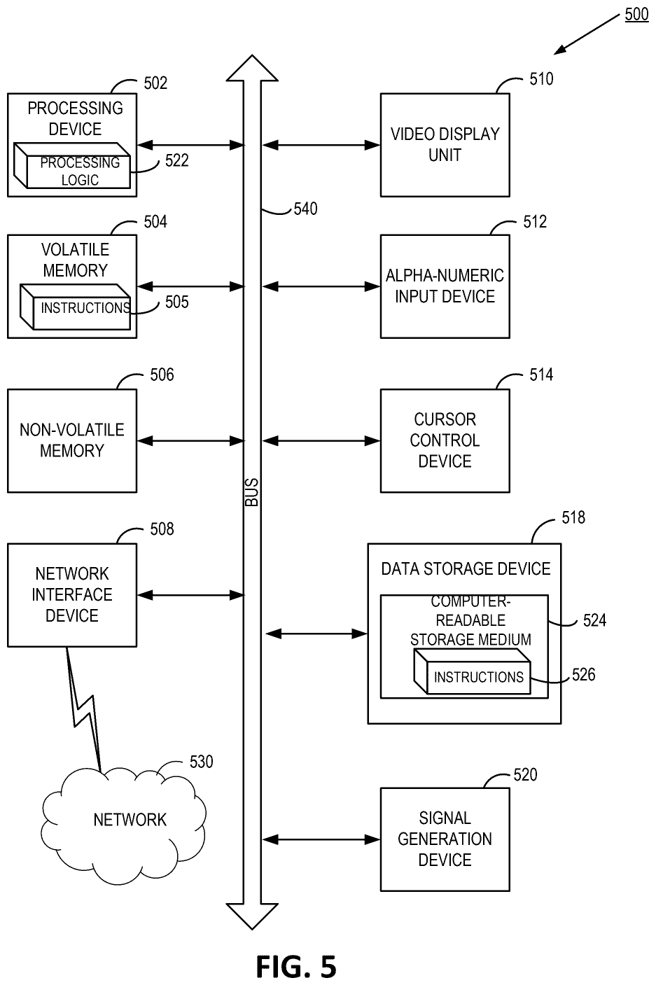

FIG. 5 is a block diagram illustrating an exemplary computer system 500, in accordance with implementations of the present disclosure. Computer system 500 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 can include processing logic 522 used to perform the operations discussed herein. The processor 502 is configured to execute instructions 505 for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory machine-readable storage medium 524 (also computer-readable storage medium) on which is stored one or more sets of instructions 526 embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “comprises,” “comprising,” “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “block,” “layer,” “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution, and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, from an image capture device, a captured image;
extracting a face image from the captured image;
aligning the extracted face image to a reference face model;
generating, using a machine learning model and based on the aligned extracted face image, a face embedding; and
identifying, based on the generated face embedding and a database of existing face embeddings, an individual associated with the face embedding.

2. The method of claim 1, wherein aligning the extracted face image to a reference face model comprises:
identifying a set of landmarks from the extracted face image;
obtaining, from the set of landmarks, a subset of the set of landmarks;
determining, using the subset, the reference face model, and a homogenous transformation, parameters of homogenous transformation; and
applying the homogenous transformation with the determined parameters to each pixel of the extracted face image.

3. The method of claim 2, wherein the subset comprises a left eye of the face image, a right eye of the face image, and a middle of a lip of the face image.

4. The method of claim 1, wherein generating the face embedding comprises:
inputting, into the machine learning model, the aligned extracted face image to output the face embedding; and
reducing a dimension of the face embedding.

5. The method of claim 1, wherein determining, based on the generated face embedding and the database of existing face embeddings, the individual associated with the face embedding comprises:
for each existing face embedding of the database of existing face embeddings, calculating a similarity score between the generated face embedding and a respective existing face embedding; and
comparing the calculated similarity score of between the generated face embedding and the respective existing face embedding to a similarity score threshold value of the respective existing face embedding.

6. The method of claim 1, wherein determining, based on the generated face embedding and the database of existing face embeddings, the individual associated with the face embedding comprises:
for each cluster of existing face embeddings within the database of existing face embeddings, obtaining a representative face embedding for a respective cluster of existing face embeddings;
for each representative face embedding, calculating a similarity score between the generated face embedding and the representative face embedding; and
comparing the calculated similarity score of between the generated face embedding and the representative face embedding to a similarity score threshold value of the representative face embedding.

7. The method of claim 5, wherein each cluster of existing face embeddings in the database of existing face embeddings corresponding to an individual is assigned a unique similarity threshold value.

8. The method of claim 1, wherein the database of existing face embeddings includes an embedding of each user at various orientations.

9. A non-transitory computer-readable medium comprising instructions that, responsive to execution by a processing device, cause the processing device to perform operations comprising:
receiving, from an image capture device, a captured image;
extracting a face image from the captured image;
aligning the extracted face image to a reference face model;
generating, using a machine learning model and based on the aligned extracted face image, a face embedding; and
identifying, based on the generated face embedding and a database of existing face embeddings, an individual associated with the face embedding.

10. The non-transitory computer-readable medium of claim 9, wherein aligning the extracted face image to a reference face model comprises:
identifying a set of landmarks from the extracted face image;
obtaining, from the set of landmarks, a subset of the set of landmarks;
determining, using the subset, the reference face model, and a homogenous transformation, parameters of homogenous transformation; and
applying the homogenous transformation with the determined parameters to each pixel of the extracted face image.

11. The non-transitory computer-readable medium of claim 10, wherein the subset comprises a left eye of the face image, a right eye of the face image, and a middle of a lip of the face image.

12. The non-transitory computer-readable medium of claim 9, wherein generating the face embedding comprises:
inputting, into the machine learning model, the aligned extracted face image to output the face embedding; and
reducing a dimension of the face embedding.

13. The non-transitory computer-readable medium of claim 9, wherein determining, based on the generated face embedding and the database of existing face embeddings, the individual associated with the face embedding comprises:
for each existing face embedding of the database of existing face embeddings, calculating a similarity score between the generated face embedding and a respective existing face embedding; and
comparing the calculated similarity score of between the generated face embedding and the respective existing face embedding to a similarity score threshold value of the respective existing face embedding.

14. The non-transitory computer-readable medium of claim 9, wherein determining, based on the generated face embedding and the database of existing face embeddings, the individual associated with the face embedding comprises:
for each cluster of existing face embeddings within the database of existing face embeddings, obtaining a representative face embedding for a respective cluster of existing face embeddings;
for each representative face embedding, calculating a similarity score between the generated face embedding and the representative face embedding; and
comparing the calculated similarity score of between the generated face embedding and the representative face embedding to a similarity score threshold value of the representative face embedding.

15. The non-transitory computer-readable medium of claim 13, wherein each cluster of existing face embeddings in the database of existing face embeddings corresponding to an individual is assigned a unique similarity threshold value.

16. The non-transitory computer-readable medium of claim 9, wherein the database of existing face embeddings includes an embedding of each user at various orientations.

17. A system comprising:
an image capture device; and
a processing device coupled to the image capture device, wherein the processing device is to perform operations comprising:
receiving, from the image capture device, a captured image;
extracting a face image from the captured image;
aligning the extracted face image to a reference face model;
generating, using a machine learning model and based on the aligned extracted face image, a face embedding; and
identifying, based on the generated face embedding and a database of existing face embeddings, an individual associated with the face embedding.

18. The system of claim 17, wherein aligning the extracted face image to a reference face model comprises:
identifying a set of landmarks from the extracted face image;
obtaining, from the set of landmarks, a subset of the set of landmarks;
determining, using the subset, the reference face model, and a homogenous transformation, parameters of homogenous transformation; and
applying the homogenous transformation with the determined parameters to each pixel of the extracted face image.

19. The system of claim 17, wherein generating the face embedding comprises:
inputting, into the machine learning model, the aligned extracted face image to output the face embedding; and
reducing a dimension of the face embedding.

20. The system of claim 17, wherein determining, based on the generated face embedding and the database of existing face embeddings, the individual associated with the face embedding comprises:
for each cluster of existing face embeddings within the database of existing face embeddings, obtaining a representative face embedding for a respective cluster of existing face embeddings;
for each representative face embedding, calculating a similarity score between the generated face embedding and the representative face embedding; and
comparing the calculated similarity score of between the generated face embedding and the representative face embedding to a similarity score threshold value of the representative face embedding.
